(19) United States
(12) Patent Application Publication
(10) Pub. No.: US 2004/0086214 A1
(43) Pub. Date: May 6, 2004

(54) Optical circulator for bi-directional communication

(75) Inventors: Yonglin Huang, Milptas, CA (US); Qi Deng, Cupertino, CA (US); Robert Huang, Fremont, CA (US); Liren Du, San Jose, CA (US); Steve Wang, San Jose, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(73) Assignee: Finisar Corporation

(21) Appl. No.: 10/623,827

(22) Filed: Jul. 21, 2003

Related U.S. Application Data
(63) Continuation-in-part of application No. 10/617,006, filed on Jul. 10, 2003.
(60) Provisional application No. 60/394,774, filed on Jul. 10, 2002.
(60) Provisional application No. 60/397,969, filed on Jul. 23, 2002.
(60) Provisional application No. 60/397,971, filed on Jul. 23, 2002.
(60) Provisional application No. 60/397,967, filed on Jul. 23, 2002.
(60) Provisional application No. 60/398,056, filed on Jul. 23, 2002.
(60) Provisional application No. 60/397,851, filed on Jul. 23, 2002.
(60) Provisional application No. 60/397,728, filed on Jul. 23, 2002.
(60) Provisional application No. 60/397,970, filed on Jul. 23, 2002.
(60) Provisional application No. 60/397,852, filed on Jul. 23, 2002.
(60) Provisional application No. 60/397,963, filed on Jul. 23, 2002.
(60) Provisional application No. 60/395,413, filed on Jul. 13, 2002.

(51) Int. Cl. G02B 6/00

(52) U.S. Cl. 385/11

(57) ABSTRACT

A low-cost circulator used in fiber optic networks to accomplish bi-directional communication along a single fiber optic cable. The circulator has three ports, namely an input port, an output port and a bi-directional network port. The circulator core is constructed such that when light with a specific polarization is input into the input port, it is bent into the bi-directional network port where it can be propagated to the fiber optic network. Light input from the bi-directional network port can be any state of polarization, and it passes through the circulator core to the output port.

### CROSS-REFERENCE TO RELATED APPLICATIONS

This application is a continuation-in-part application of U.S. patent application Ser. No. ______, which was filed on Jul. 10, 2003 and entitled “Single-Fiber Bi-Directional Transceiver”, which claims priority to and the benefit of U.S. Provisional Patent Application No. 60/394,774, filed Jul. 10, 2002 and entitled “Single-Fiber Bi-Directional Transceiver”; No. 60/397,969, filed Jul. 23, 2002, entitled “Plug-in Module Having a Receptacle for Receiving Bi-Directional Data Transmission”; No. 60/397,971, filed Jul. 23, 2002, entitled Plug-in Module Having a Receptacle for Receiving Bi-Directional Data Transmission”; No. 60/397,967, filed Jul. 23, 2002, entitled, “Optical Circulator Using a Prism for Bi-Directional Communication”; No. 60/398,056, filed Jul. 23, 2002, entitled, “Low Cost Optical Circulator for Bi-Directional Communication”; No. 60/397,851, filed Jul. 23, 2002, entitled, “Optical Circulator with Dual Receive Path for Bi-Directional Communication”; No. 60/397,728, filed Jul. 23, 2002, entitled, “Optical Circulator with Dual Receive Path and Quarter Wave-Plate for Bi-Directional Communication”; No. 60/397,970, filed Jul. 23, 2002, entitled, “Optical Circulator with Adjacent Transmit and Receive Ports for Bi-Directional Communication”; No. 60/397,852, filed Jul. 23, 2002, entitled, “Optical Circulator with Beam Displacer for Bi-Directional Communication”; No. 60/397,963, filed Jul. 23, 2002, entitled, “Optical Circulator with Dual Beam Displacers for Bi-Directional Communication”; and No. 60/395,413, filed Jul. 13, 2002, entitled “Optical Pump Module”; all of which are hereby incorporated by reference in their entireties.

### BACKGROUND OF THE INVENTION

1. The Field of the Invention

The invention generally relates to the field of fiber optic communications. More specifically, the invention relates to a low cost integrated solution for accomplishing bi-directional fiber optic communication along a single fiber optic cable.

2. The Relevant Technology

In the field of data transmission, one method of efficiently transporting data is through the use of fiber optics. Digital data is propagated through a fiber optic cable using light emitting diodes or lasers. Use of light as a carrier for data or signals provides many benefits over propagating data using conventional conductive-wire systems. For instance, optical fibers allow for extremely high data transmission rates and very high bandwidth capabilities. Furthermore, signals carried in propagating light are resistant to electromagnetic interferences that would otherwise interfere with electrical signals. Additionally, data carried in propagating light is more secure because portions of the signal do not escape from the fiber optic cable as may occur with electrical signals in wire-based systems. Finally, light signals may be propagated over greater distances than conducting signals along copper wires without the signal loss typically associated with electrical signals on copper wire.

One method of achieving bi-directional communication using an optical fiber or cable is through the use of two fiber optic cables. A first cable transmits data from a device on the network, while the second cable receives the data. Although this configuration provides adequate communication capabilities, it is often desirable to limit the number of fiber optic cables between two communication points to save on material costs and installation. One method of limiting the number of cables is by sending and receiving data on the same fiber optic cable, which is possible because of the directional nature of an optical signal that is propagated along a fiber optic cable. Generally, splitters or circulators aid with achieving bi-directional communication on a single fiber optic cable.

A common splitter design is shown in FIG. 1A. Splitter 100 includes a number of ports through which data may be input or output. In the illustrated configuration, a transceiver (not shown) sends an optical signal through a port, such as port 102. The optical signal travels to a splitter plate 108 of splitter 100, which splits the optical signal in two directions. In one example, approximately half of the optical signal is sent towards a decimation path 112, while the remaining portion of the optical signal propagates into a port, as represented by numeral 106. Data being received by splitter 100 may also travel through port 106 into splitter 100. The splitter plate 108 reflects half of the light to a reflector 110. The reflector 110 reflects this portion of the light towards a port 104. Any light reflected to decimation path 112 is wasted. Examining FIG. 1, it can be seen that that about 50% of the initial power or 3 dB is lost using the splitter method of bi-directional communication at each terminal. For a transceiver pair, the total loss of using this splitter may be as high as 6 dB.

Another method of bi-directional communication along a single fiber optic cable involves the use of three-port optical circulator, such as shown in FIG. 1B. An optical circulator is generally a device having three or more ports, by which an optical signal input into one port is output at the next port in either a clockwise or a counterclockwise direction. For example, an optical signal input at port_{A} of optical circulator 120 exits at port_{B}. An optical signal input at port_{B} exits at port_{C}. In a three-port device, an optical signal input at port_{C} exits at port_{A}. The drawback of using currently available circulators for this type of communication is that currently available circulators are expensive to implement.

The third conventional method of bi-directional communication along a single fiber-optic cable involves the use of lasers with different wavelengths. Commonly, a 1550 nanometer distributed feedback (DFB) laser is used to propagate an optical signal in one direction, and a 1310 nanometer vertical cavity surface emitting laser (VCSEL) is used to propagate a different optical signal in the opposite direction. One drawback with this configuration is that it requires two types of transceivers with different transceivers being used at the two communications devices engaging in the bi-directional communication.

For example, one of the two communications devices typically has a transceiver with a 1550 nanometer transmitter and a 1310 nanometer receiver. In contrast, the other of the two communications devices has a complementary transceiver having a 1310 nanometer transmitter and a 1550 nanometer receiver. Further, in the case where there is a chain of network devices, the types of transceivers are alternated along the chain, and any change within the chain necessitates careful network construction to maintain the alternating transceivers. Requiring two types of transceivers increases production and maintenance costs.

A second drawback of the dual wavelength transmitter/receiver approach to bi-directional communication is that the 1550 nanometer DFB laser is very expensive as compared to the 1310 nanometer VCSEL. Therefore it would be beneficial to use only the cheaper 1310 nanometer VCSEL.

Different optical components may be incorporated within an optical device used to aid with bi-directional delivery of data using carrier light. For instance, in isolation circuits, a collimating lens is used to direct light in a parallel path. Prisms may also be used to direct light in a particular direction. Often prisms take the form of a wedge of optically transmitting material having a defined optical axis and optical properties. For example, FIGS. 2A and 2B are samples of prisms having particular optical properties. In FIG. 2A, prism 202 has an optical axis of 0°, while FIG. 2B depicts a prism 204 having an optical axis of 45°. Putting those two prisms together, as shown in FIG. 2C, produces a Rochon prism known in the art.

Other optical devices that may facilitate bi-directional communication may include a polarization rotator, a polarizing beam splitter, and a beam displacer. A polarization rotator may be a wave plate or a combination of a garnet and a magnetic field. Each polarization rotator may be used to adjust the state of polarization of a beam of light.

Similarly, a polarizing beam splitter (PBS) controls the passage of light therethrough depending on the state of the polarization of the light. The PBS can be used to polarize light to a given state depending on the optical axis of the PBS. Polarizing beam splitters are typically constructed from birefringent materials. A birefringent material is a meterial having two indices of refraction associated with it. Light passing through the birefringent material is split into two orthogonal beams, an ordinary beam in which the primary index of refraction affects travel according to Snell's law for the primary index of refraction, and an extraordinary beam in which the secondary index of refraction affects travel according to Snell's law for the secondary index of refraction. If light is input into the PBS at a state of polarization that matches the axis of one of the indices of refraction, the light will not be split, but will travel through the PBS according to the index of refraction corresponding to the state of polarization of the light.

A beam displacer may also be constructed of birefringent material. In a similar manner to the PBS, the beam displacer may act as a polarizer. Therefore, the beam displacer may split a light beam into two orthogonal components.

### BRIEF SUMMARY OF THE INVENTION

A low cost optical circulator used for bi-directional communication in a fiber optic communications system is disclosed. The low cost optical circulator has a transmit node, a receive node, and a bi-directional communication node. The low cost optical circulator core is made non-reciprocal by using appropriate optical components, such as, but not limited to, birefringent wedges, lenses, and one or more Faraday rotators. Numerous configurations of wedges, rotators, and lenses are applicable to enable effective operation of the circulator. The core of the optical circulator enables light propagating into the transmit node with a well-maintained state of polarization to be output at the bi-directional node. Light propagating into the bi-directional node with any state of polarization propagates to the receive node of the optical circulator.

The illustrated optical circulator receives inputs through two of the three ports. Because, in one configuration, the circulator is used as a duplex communication module, one port only receives data, resulting in the desired bi-directional communication on a single optical fiber coupled to the optical circulator. Therefore, one port represents the transmit line, one port represents a receive line, while one port acts as the interface to the single fiber transmission network.

In another embodiment of the invention, a method for transmitting bi-directional data in a fiber optic network is disclosed. The method uses an optical circulator that has transmit, receive, and network fibers connected to a non-reciprocal optical core. The optical core is constructed such that light traveling in a transmit direction is of a well maintained state of polarization and as such, may be directed to the network fiber. Light input from the network fiber may be of any state of polarization and is directed by the optical core to the receive fiber. The disclosed embodiment includes inputting a beam with a well-maintained state of polarization into the transmit fiber, receiving a beam with any state of polarization in the receive fiber, and propagating light beams in both the transmit and receive directions along the bi-directional network communications fiber.

In yet another embodiment of the invention, a method for making an optical circulator for use in bi-directional communications is disclosed. The method involves connecting a network fiber to a first lens. The lens is then connected to an optically non-reciprocal core designed to transmit data in both transmit and receive directions. The non-reciprocal core may only accept light with a well maintained state of polarization in the transmit direction. The non-reciprocal core connects to a second lens that is connected to transmit and receive fibers.

These and other objects and features of the present invention will become more fully apparent from the following description and appended claims, or may be learned by the practice of the invention as set forth hereinafter.

### BRIEF DESCRIPTION OF THE DRAWINGS

The appended Figures contain various embodiments of the present invention. The above-mentioned features of the invention, as well as other features, will be described in connection with the disclosed embodiments. However, the illustrated embodiments are only intended to illustrate the invention and not to limit the invention. The drawings contain the following figures:

FIG. 1A is a prior art drawing of a splitter used for bi-directional communication.

FIG. 1B illustrates a typical three-port circulator device.

FIGS. 2A and 2B are perspective views of optical birefringent wedges used in the construction of optical circulators.

FIG. 2C is a perspective view of a current Rochon prism.

FIG. 2D is a perspective view of an assembly of wedges and a Faraday rotator used as an optical circulator.

FIG. 3 shows an embodiment of the core, lenses, and optical fibers in a low-cost integrated circulator.

FIG. 4 shows an alternative embodiment of a low-cost optical circulator according to another aspect of the present invention;

FIGS. 5A and 5B are drawings of another alternative embodiment of an optical circulator according to the present invention.

FIGS. 6A and 6B are drawings of another alternative embodiment of an optical circulator according to the present invention.

FIGS. 7A and 7B are drawings of yet another alternative embodiment of an optical circulator according to the present invention.

FIGS. 8A, 8B and 8C are drawings of yet another alternative embodiment of an optical circulator according to the present invention.

FIGS. 9A and 9B are drawings of yet another alternative embodiment of an optical circulator according to the present invention.

FIGS. 10A, 10B and 10C show several possible interconnections for a circulator device used to connect the circulator to an optical network according to another aspect of the present invention.

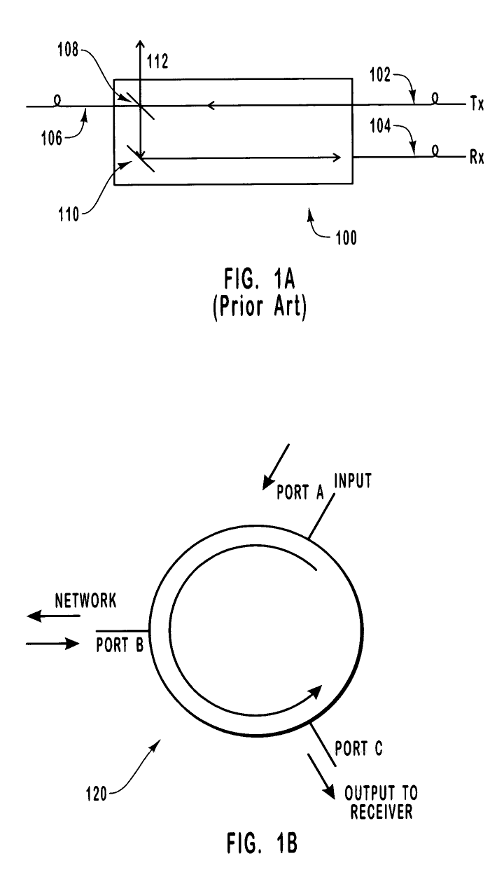

### DETAILED DESCRIPTION OF PREFERRED EMBODIMENTS

The present invention generally is a low-cost optical circulator that functions to change two-fiber duplex communication to one fiber bi-directional duplex communication and provides novel optical cores to achieve the desired bi-directional duplex communication. The optical circulator of the present invention includes various ports, such as but not limited to, a transmit port, a receive port, and a network port, each of which receives an optical fiber, that optically communicates with a non-reciprocal optical core. An optical signal traveling toward the optical core through the network port is directed toward the receive port. Similarly, optical signals traveling toward the optical core through the transmit port are directed toward the network port. In this configuration, the optical circulator receives no input signals through the receive port. This is in contrast to existing circulators that may receive inputs on all ports. With this configuration, the optical circulator of the present invention acts as a bi-directional communication module.

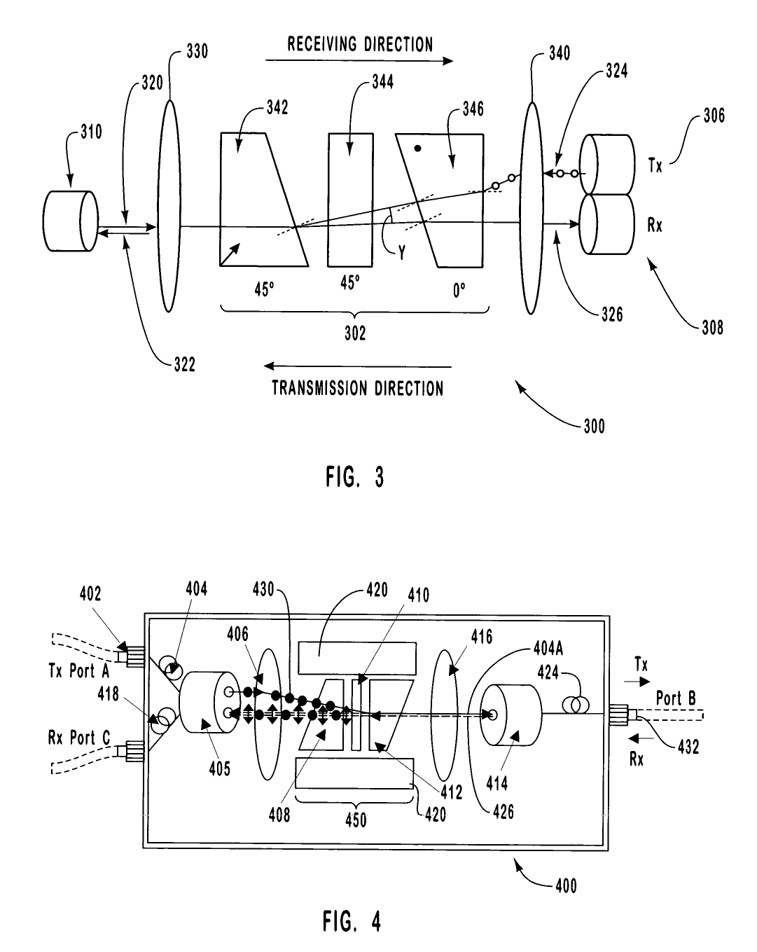

Reference will now be made to FIGS. 3-10 to describe exemplary embodiments of the present invention. It is to be understood that the Figures are diagrammatic and schematic representations of presently preferred embodiments, and are not limiting of the present invention, nor are they necessarily drawn to scale.

While the accompanying Figures represent different embodiments of the present invention, it is understood by those of skill in the art that many other embodiments of the present invention are contemplated. The present invention uses an optical core that facilitates the transfer of light signals from a transmitter to a network node and from a network node to a receiver. The various embodiments are provided to illustrate different ways to achieve the invention depending on the orientation of the transmit, receive, and network nodes. For example, all three nodes could be on the same side of the device. Alternately, the nodes could be established in any orientation, including on the ends, sides, top or bottom of the device, and an optical core designed to move the light signals to the desired locations.

Referring to FIG. 3, shown is one embodiment of a circulator, identified by reference numeral 300, which functions to provide bi-directional duplex communication. The circulator 300 includes an optical core 302 that optically communications with a transmit fiber 306, a receive fiber 308, and a network fiber 310 by way of lenses 330 and 340. The transmit fiber 306, which is polarization maintaining (PM), and receiver fiber 308 optically couple to the transceiver end of optical core 302, while network fiber 310 optically couples to the network end of optical core 302.

The network fiber 310, transmit fiber 306, and receive fiber 308 may also have connectors attached to their free ends. In one embodiment, the connectors are of a standard form factor such that they can be coupled to existing fiber optic networks. The network fiber 310 may be a pigtail fiber with a connector at the free end, or alternatively a receptacle for receiving a standard form factor pigtail. The transmit and receive connectors may be arranged such that they plug directly into a standard form factor transceiver. The construction and use of these connectors are outlined in co-pending U.S. patent application Ser. No. ______, dated ______, and entitled “Plug-In Module Having a Receptacle for Receiving Bi-Directional Data Transmission”, which is hereby incorporated by reference in its entirety.

Light from transmit fiber 306 is transmitted with a well-maintained state of polarization to pass through optical core 302 and to be output to net-work fiber 310. The network fiber 310 is adapted to propagate bi-directional communication signals such that simultaneously, light from the optical network is transmitted from network fiber 310 with any state of polarization through optical core 302 where it is output at receive fiber 308.

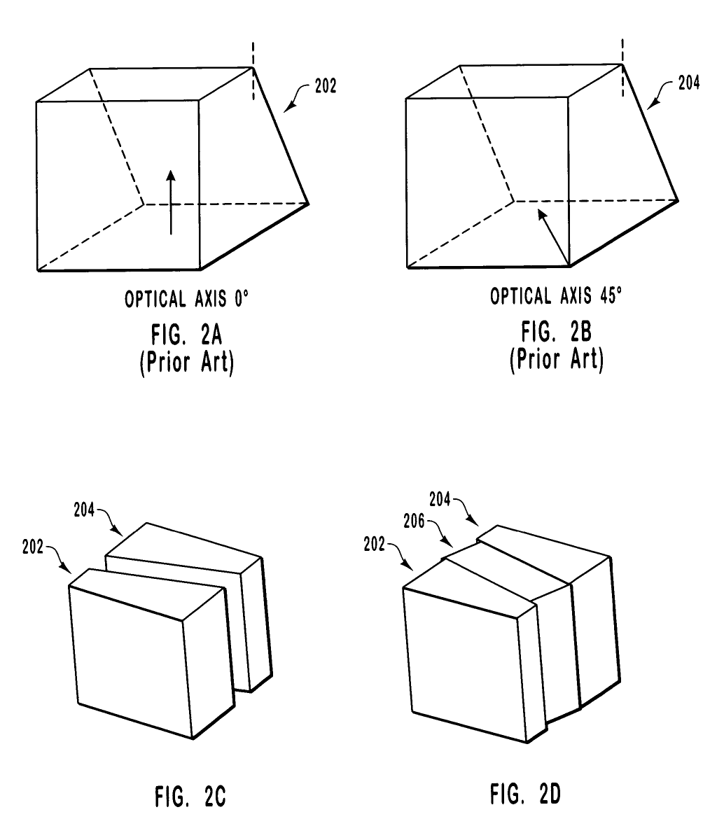

The circulator 300 uses, as optical core 302, two optical birefringent wedges 342 and 346 and a Faraday rotator 344 disposed between the two optical birefringent wedges 342 and 346. Wedge 342, in one configuration, may have an optical axis of 0°, while wedge 346 may have an optical axis of 45°. In this configuration, wedges 342 and 346 collectively function as a Rochon prism, such as the prism depicted in FIG. 2C, to polarize light passing therethrough. Although reference is made to this particular configuration, one skilled in the art will understand that various other devices could be used, such as, but not limited to, Wollaston prisms, Glean-Thompson prisms, Glean-Taylor prisms, or even thin film cubes.

To cause optical circulator 300 to be optically non-reciprocal, Faraday rotator 344 is inserted in between the two wedges 342 and 346. This rotator 344 rotates the polarization plane of input optical signal based on the initial polarization orientation of the input beam. This rotator 344 may be in contact with at least one surface of each wedge 342 and 346. Alternatively, rotator 344 may be separated from each wedge 342 and 346, thereby creating air gaps between rotator 344 and wedges 342 and 346. Rotator 344 may be fabricated from a magneto-optic material, such as a YIG crystal, or other material that provides the optical properties or characteristics associated with rotator 344.

In addition, rotator 344 may utilize a latching magnetic material or a non-latching magnetic material. For non-latching material, an external magnet may be used to apply a magnetic field, while a rotator fabricated from a latching material does not need an external magnetic field. In one example, when circulator 300 is intended to be used in an environment with stray magnetic fields, a non-latching material design may be used as the external magnets are better able to control the polarization changes of light traveling within circulator core 302. This is true because the external magnets exert a much stronger magnetic field on the light than the stray magnetic influences. If designs using a latching material were placed in an environment containing stray magnetic fields, the stray magnetic fields may cause a polarization shift in the light traveling in circulator core 302. The present example shows a latching material design. A non-latching design is shown generally in FIG. 4.

Following hereinafter is a discussion of the operation of circulator 300. To aid with the description, FIG. 3 includes ray traces 320, 322, 324, and 326 indicating the path that the optical signals may take as they propagate through circulator 300. In the transmission direction, a linearly polarized beam of electromagnetic radiation or light from transmit fiber 306, shown as trace 324, comes to optical core 302 through lens 340 that collimates the input optical signals. These collimated optical signals are transmitted into network fiber 310, as shown by trace 322. Depending on the orientation of the wedges 342, 346, the polarization direction of the electromagnetic radiation or light 324 may be either parallel or perpendicular to the optical axis of wedge 342.

Because wedge 346 is birefringent, a beam passing through the wedge will usually be split into an ordinary (o) beam and an extraordinary (e) beam. An o beam typically travels through a birefringent material according to Snell's law dependant on one index of refraction of the birefringent material. The e beam on the other hand reacts to a second index of refraction and behaves differently than the o beam. In this case however, because the polarization direction of beam 324 is parallel to the optical axis, there is no o beam, and beam 324 acts as an e beam.

After traveling through Faraday rotator 344, the polarization direction of beam 324 is rotated by 45°, so that the polarization direction is perpendicular to the optical axis of wedge 342. As is true for a Rochon prism, the refractive indices encountered by the o and e beams as they pass through wedges 342 and 346 are different, such that optical core 302 bends beam 324 and it is then output as trace 322. The angle γ between traces 324 and 322, is described as follows:

γ=arcsin[(nₒ−nₑ)·tan θ] (1)

where θ is the wedge angle, and nₒ, nₑ are the refractive indices for the ordinary beam and the extraordinary beam in the two birefringent crystal wedges 342, 346. In the present case, the beam 324 acts like an o beam and is refracted such that it can be focused into the bi-directional communications fiber 310 via lens 330.

In the receiving direction the beam is transmitted from network fiber 310, as shown by trace 320, without any defined state of polarization. The receive beam generally does not have a well-defined state of polarization, because the receive beam is typically received after being transmitted through a lengthy segment of optical fiber. The beam passes through core 302, as shown by trace 326, and is directed into receive fiber 308. When trace 326 passes through the wedge 342, it will be slightly split into an e beam and an o beam. When these two beam components pass through Faraday rotator 344, both components will be rotated by 45°. When the two beam components enter wedge 346, where the optical axis is 45° apart from wedge 342, the e and o beams keep their refractive indices as in wedge 342, so that the wedges are complementary, the output beam 326 is bent almost parallel to trace 320 and can only enter fiber 308.

As can be appreciated by those skilled in the art, the optical axes of the respective wedges and the angle of rotation of the Faraday rotator may be other values than those in this example and still maintain the non-reciprocal transmission effects. For instance, the optical axis may be greater than about 0°, lesser or greater than 45°, or some other angle. So long as the wedges and Faraday rotator are chosen to function with the particular well maintained state of polarization of the transmit beam 324, whether it be some particular known angle or circularly polarized, the low cost optical core can be implemented in a variety of configurations.

Additionally, other optical components could be used in core 302 to achieve the desired optical results. These components may include other types of prisms, garnets, half wave plates and quarter wave plates optically tuned to the frequency of the light to be transmitted, and/or polarization beam splitters. Other embodiments of the present invention utilizing various combinations of these components are discussed below with reference to FIGS. 4-9.

Another example of an optical circulator is illustrated by the circulator shown in FIG. 4, identified by reference numeral 400. The discussion with respect to circulator 300 is also applicable to circulator 400. As illustrated, circulator 400 includes an optical core 450 through which optical signals pass as they propagate from a transmit port 402 to a network port 432 and from network port 432 to receive port 422. It is understood that each port 402, 422 and 432 may include associated optical fibers and connectors between the optical fibers and circulator 400, as illustrated in dotted lines. For instance, standard form factor connectors, ferrules, and other types of optical connectors are contemplated and fall within the scope of the present invention.

Optical signals propagating through ports 402 and 422 may pass along one or more optical fibers 404, 418 disposed within a fiber pigtail 405. The pigtail 405 maintains optical fibers 404, 418 in the correct position relative to optical core 450 of circulator 400 so that the optical signals may propagate therethrough. Similarly, optical signals propagating through port 432 may pass along one or more optical fibers 424 disposed within a fiber pigtail 414 having a similar configuration to pigtail 405.

The optical core 450 of circulator 400 has a similar configuration to optical core 302 of circulator 300. To aid with explanation, an external magnet 420 is illustrated as at least partially surrounding optical wedges 408 and 412, and Faraday rotator 410. The magnet 420 creates the magnetic field that causes polarization shifts in the optical signals as they propagate through Faraday rotator 412 and non-latching optical wedges 408 and 412.

The angled surfaces of wedges 408 and 412 are disposed in close proximity to lenses 406 and 416. This is in contrast to circulator 300 where the angled surfaces of wedges 342 and 346 are disposed in close proximity to Faraday rotator 344 of FIG. 3. Although structurally different, both circulators 300 and 400 function in the same manner. For instance, in operation, a transmit light beam 430 is transmitted from transmit port 402. The light beam 430 then passes through PM fiber 404 disposed in a dual fiber pigtail 405, with a well maintained state of polarization (SOP). Alternatively, port 402 and PM fiber 404 may be a single mode (SM) connector and SM fiber, respectively.

The beam 430 passes through a collimating lens 406, where it is directed into and is bent by optical core 450, i.e., the assembly of wedge 408, a magneto-optic material, such as a Faraday rotator fabricated from a YIG crystal (garnet) 410, and a wedge 412. The resultant beam 430 is focused into single fiber pigtail 414 by a lens 416, before propagating through network port 432 and associated optical fibers, illustrated by dotted lines.

Optionally simultaneously, a second beam, called a receive beam 426, propagates in an opposite direction with respect to transmit beam 430. The receive beam 426 propagates along pigtail 414 and generally does not have a well-defined state of polarization, because receive beam 426 is typically received after being transmitted through a lengthy segment of optical fiber. The receive beam 426 is collimated by lens 416 and propagates through optical core 450, due to its direction of travel. This receive beam 426 is not deflected as transmit beam 430 is deflected. This receive beam 426, therefore, is focused into receive port 422 and associated optical fiber forming part of dual fiber pigtail 405.

Following hereinafter is a discussion of various alternate embodiments of the optical core forming part of the circulator of the present invention, such as, but not limited to, circulators 300 and 400. The discussion specific to each optical core is also applicable to the discussion of other optical cores disclosed herein and otherwise identifiable in light of the teaching contained herein. While each embodiment discloses an optical core having specific optical components assembled in a defined manner, those skilled in the art will realize that other combinations of components may be used to achieve the same results within a particular embodiment. It is anticipated that all optical cores which achieve the objectives of the invention are contemplated herein. Specific core assemblies of polarization beam splitters, beam displacers, wedges, Faraday rotators, garnets, half-wave plates, quarter-wave plates, and mirrors that accomplish the objectives of the present invention are all contemplated and included herein.

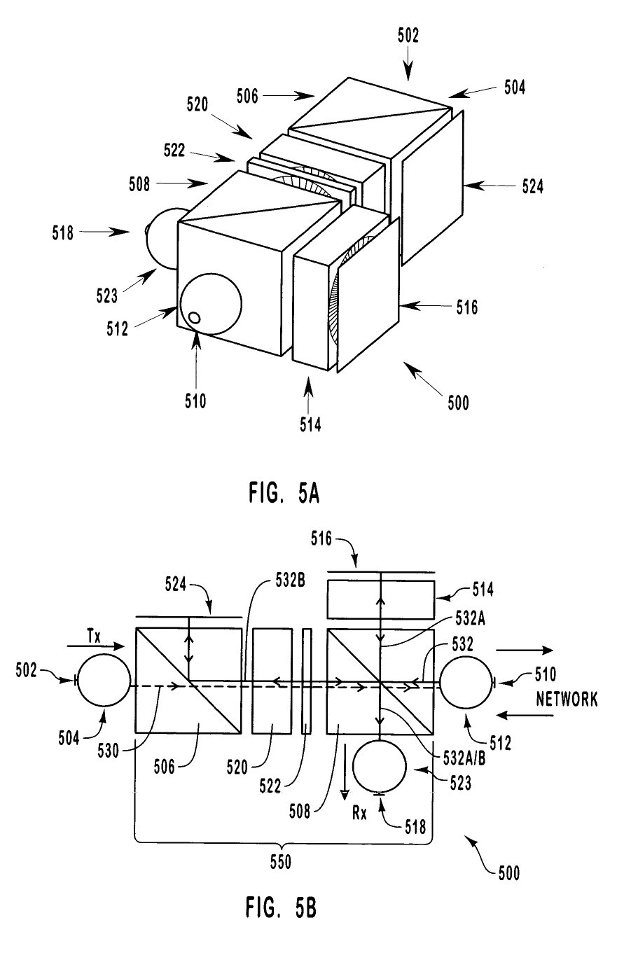

An alternate embodiment of an optical device according to the teaching of the present invention is illustrated in FIGS. 5A and 5B. With reference to FIG. 5A, the circulator 500 includes a laser diode 502 optically coupled to a first lens 504. This first lens 504 is optically coupled to an optical core 550 containing various optical components that reflect, refract, and/or change the polarization state of a beam passing therethrough. Also optically communicating with optical core 550 are a second lens 512 that optically communicates with a fiber 510 associated with the network node of circulator 500. Similarly, core 550 also optically communicates with a lens 523 that directs electromagnetic radiation received from the network node to a photodetector 518 associated with the receive node of circulator 500.

In this illustrated configuration the network node and the receive node are at the same end of circulator 500, while the transmit node is at another end of circulator 500. One skilled in the art will appreciate that the position of the network node, the receive node, and the transmit node may be varied. For instance, the network node may be disposed at the same end as the transmit node or the receive node may be disposed at the same end as the transmit node.

With reference to FIG. 5B, core 550 may include a first polarization beam splitter 506 optically coupled to first lens 504 and a garnet 520. Garnet 520 in turn is optically coupled to wave plate 522. The combination of garnet 520 and wave plate 522 may be termed a polarization shifting assembly since garnet 520 and wave plate 522, individually and collectively, may shift the polarization of electromagnetic radiation propagating therethrough. Various other optical components may be used to perform this function.

Wave plate 522 optically communicates with a second polarization beam splitter 508. Second polarization beam splitter 508 is optically coupled on a first side to lens 523, on a second side to lens 512, and on a third side to garnet 514. The garnet 514 is also optically coupled to mirror 516. The optical core 550 defined by the above elements functions similarly to the optical cores discussed previously. The functions of the various components of optical core 550 are discussed below.

In circulator 500, a light beam 530, depicted by dotted lines, from laser diode 502 of a transmitter portion of a transceiver, with a well-defined SOP, is collimated by lens 504. The light beam 530 from laser diode 502 enters core 550 through a first or transmit port of circulator 500. This first port accepts light with a well-maintained or defined SOP. By accepting light only with a well-defined SOP, the circulator function may be accomplished using a reduced number of components. In the configuration, because the SOP of the light is parallel, light beam 530 follows an optical path through polarizing beam splitter (PBS) 506 almost without reflection. The light beam 530, keeping the same SOP, continues its optical path through PBS 508 because garnet 520 and wave plate 522, such as, a half wave plate, each change the SOP of beam 530 by the same 45° angle, but in opposite directions. Finally, light beam 530 propagates into fiber 510 through lens 512 to complete its optical path to the second or network port of circulator 500. The fiber 510 optically couples to an optical network and allows light beam 530 to be transmitted onto the optical network.

In the backward optical path, a light beam 532 from optical fiber 510 traveling towards optical circulator 500 from the optical network is collimated by the lens 512 at the second port of circulator 500. The second port of circulator 500 transmits light in both forward and reverse directions, not matter the particular SOP of the light beams passing therethrough.

The light beam 532 is split into two beams, beam 532A and beam 532B with orthogonal SOPs by PBS 508. These split beams follow different optical paths before being incident upon lens 523 and photodiode 518. The split beam with a vertical SOP, i.e., beam 532A, propagates along an optical path resulting in beam 532A being reflected by PBS 508. The vertical beam 532A then propagates through garnet 514 and is reflected back by mirror 516 so as to propagate through garnet 514 again. Its SOP is rotated by garnet 514 twice in the same direction so that the SOP is changed to horizontal and beam 532A passes through PBS 508 without reflection. Finally, beam 532A is focused onto photodiode 518 by lens 523. The photodiode 518 is often disposed on the receiver portion of a transceiver device. In any case, the output of the light to the photodiode 518 or to some other device represents the function typically performed by the third or receive port of a circulator.

The second split beam with a horizontal SOP, i.e., beam 532B, propagates along a different optical path through PBS 508. The SOP of second split beam 532B changes its SOP to vertical after it travels through wave plate 522 and garnet 520 because garnet 520 and wave plate 522 each rotate the SOP by 45° in same direction. The second split beam 532B is reflected by PBS 506 into mirror 524 and then reflected back. The beam 532B continues to propagate through garnet 520 and wave plate 522. The SOP remains vertical because garnet 520 and wave plate 522 each rotate the SOP by 45° but in opposite directions. Finally, second split beam 532B is reflected by PBS 508 and focused onto photodiode 518 or into the 2nd port of circulator 500 through lens 523.

It is understood that each port 502, 510 and 518 may include associated optical fibers and connectors between the optical fibers and circulator 500. For instance, standard form factor connectors, ferrules, and other types of optical connectors are contemplated and fall within the scope of the present invention. As with prior embodiments, it is also understood that alternate components that perform the same function may be substituted for the specific components of optical core 550. For instance, by way of example and not limitation, wave plates, garnets, and Faraday rotators may be configured and substituted for each other depending on the polarization rotation desired. Specific core assemblies of polarization beam splitters, beam displacers, wedges, Faraday rotators, garnets, half-wave plates, quarter-wave plates, and mirrors that accomplish the objectives of the present invention are all contemplated and included herein.

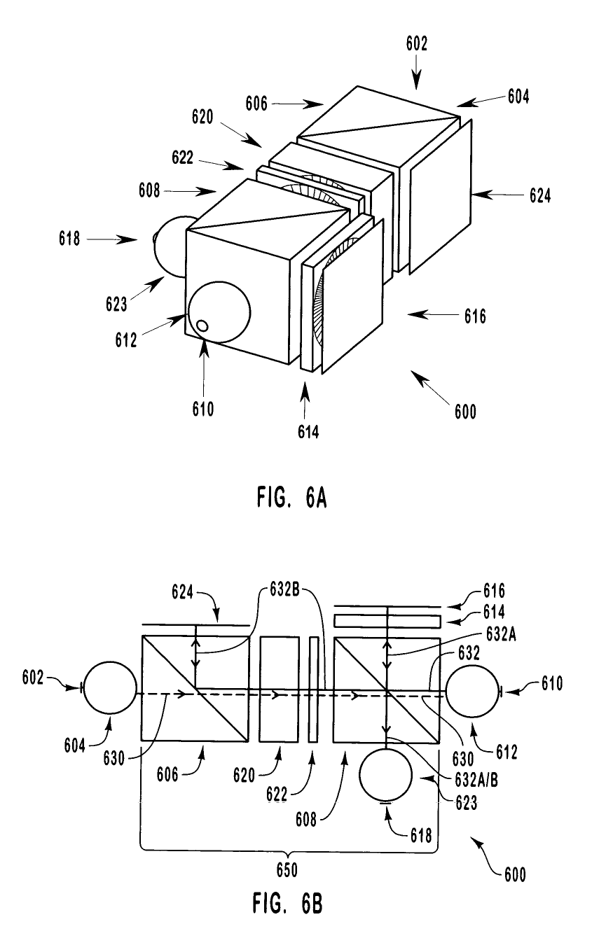

Another alternate embodiment of the optical device of the present invention is illustrated in FIGS. 6A and 6B. With reference to FIG. 6A, the circulator 600 includes a laser diode 602 optically coupled to a first lens 604. This first lens is optically coupled to an optical core 650 containing various optical components that reflect, refract, and/or change the polarization state of a beam passing therethrough. Also optically communicating with optical core 650 are a second lens 612 that optically communicates with a fiber 610 associated with the network node of circulator 600. Similarly, core 650 also optically communicates with a lens 623 that directs electromagnetic radiation received from the network node to a photodetector 618 associated with the receive node of circulator 600.

In this illustrated configuration the network node and the receive node are at the same end of circulator 600, while the transmit node is at another end of circulator 600. One skilled in the art will appreciate that the position of the network node, the receive node, and the transmit node may be varied. For instance, the network node may be disposed at the same end as the transmit node or the receive node may be disposed at the same end as the transmit node.

With reference to FIG. 6B, core 650 includes a first polarization beam splitter 606 optically coupled to the first lens 604 and a garnet 620. Garnet 620 is optically coupled to wave plate 622. The combination of garnet 620 and wave plate 622 may be termed a polarization shifting assembly since garnet 620 and wave plate 622, individually and collectively, may shift the polarization of electromagnetic radiation propagating therethrough. Various other optical components may be used to perform this function.

Wave plate 622 optically communicates with a second polarization beam splitter 608. Second polarization beam splitter 608 optically couples to lens 623 on a first side, to lens 612 on a second side, and a wave plate 614 on a third side. The wave plate 614 is also optically coupled to mirror 616. The optical core 650 functions similarly to the optical cores discussed previously. The functions of the various components of optical core 650 are discussed below.

In circulator 600, a light beam 630, depicted by dotted lines, from laser diode 602 with a well-defined SOP is input into the first port of circulator 600 and collimated by lens 604. In one example, because the SOP of the light is parallel, light beam 630 follows an optical path through PBS 606 almost without reflection. The light beam 630, keeping the same SOP, continues its optical path through PBS 608 because garnet 620 and wave plate g 622, such as a half wave plate, each change the SOP of light beam 630 by the same angle, 45°, but in opposite directions. Finally, light beam 630 propagates into fiber 610 to complete its optical path to the second or network port of circulator 600. The fiber 610 optically coupled to an optical network and allows light beam 630 to be transmitted onto the optical network.

In the backward optical path, a light beam 632 travels through the optical fiber 610 at any SOP towards the circulator 600 and is collimated by the lens 612. The second port of circulator 600 transmits light in both forward and reverse directions, not matter the particular SOP of the light beams passing therethrough.

The light beam 632 is split into two beams, beam 632A and beam 632B with orthogonal SOPs by PBS 608. The split beams follow different optical paths before being incident upon lens 623 and photodiode 618. The split beam with a vertical SOP, i.e., beam 632A, propagates along an optical path resulting in beam 632A being reflected by PBS 608. The vertical beam 532A then propagates through wave plate 614, such as a quarter wave plate, and is reflected back by mirror 616 so as to propagate through wave plate 614 again. Its SOP is changed by wave plate 614 again such that the SOP is changed to horizontal, and beam 632A passes through PBS 608 without reflection. Finally, it is focused out of the third port of the circulator 600 and onto photodiode 618 in a transceiver by lens 623.

The second split beam with horizontal SOP, i.e., beam 632B propagates along a different optical path through PBS 608. The SOP of the second split beam 632B changes its SOP to vertical after it travels through garnet 620 and wave plate 622, such as a half wave plate, because garnet 620 and wave plate 622 each rotate the SOP by 45° in the same direction. The second split beam 632B is reflected by PBS 606 into mirror 624 where it is then reflected back. The light beam 632B continues to propagate through garnet 620 and wave plate 622. The SOP of light beam 632B is rotated by garnet 620 and wave plate 622 by 45° each, but in opposite directions, such that the SOP of the light beam 632B remains vertical after passing through garnet 620 and wave plate 622. Finally, second split beam 632B is reflected by the PBS 608 and focused out of the third port of the circulator 600 and onto the photodiode 618 through lens 623.

It is understood that each port 602, 610 and 618 may include associated optical fibers and connectors between the optical fibers and circulator 600. For instance, standard form factor connectors, ferrules, and other types of optical connectors are contemplated and fall within the scope of the present invention. As with prior embodiments, it is also understood that alternate components that perform the same function may be substituted for the specific components of optical core 650. For instance, by way of example and not limitation, wave plates, garnets, and Faraday rotators may be configured and substituted for each other depending on the polarization rotation desired. Specific core assemblies of polarization beam splitters, beam displacers, wedges, Faraday rotators, garnets, half-wave plates, quarter-wave plates, and mirrors that accomplish the objectives of the present invention are all contemplated and included herein.

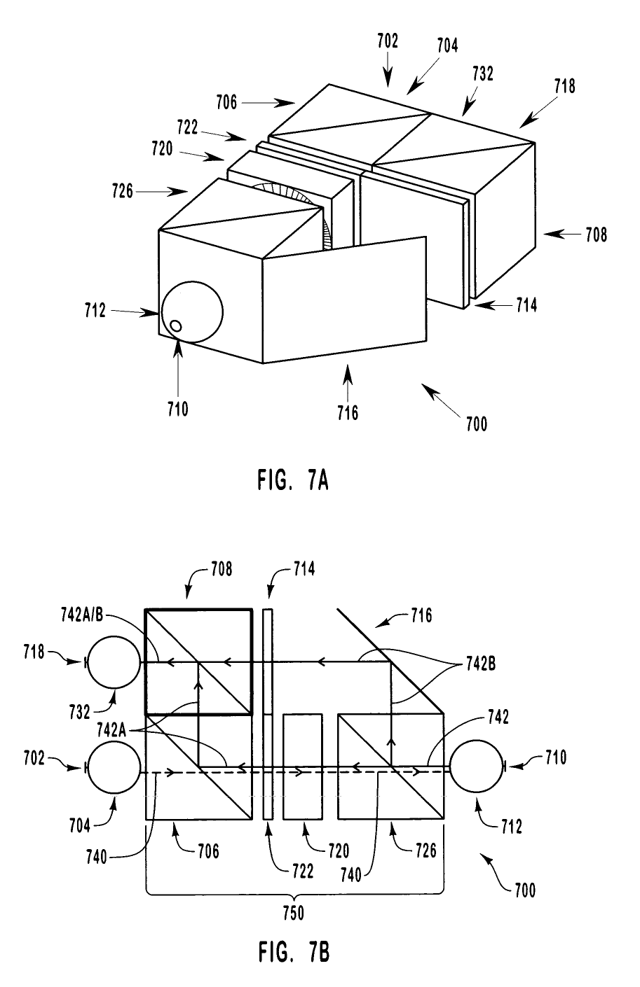

Yet another embodiment of the optical device of the present invention is illustrated in FIGS. 7A and 7B. With reference to FIG. 7A, the circulator 700 includes a laser diode 702 optically coupled to a first lens 704. This first lens 704 is optically coupled to an optical core 550 containing various optical components that reflect, refract, and/or change the polarization state of a beam passing therethrough. Also optically communicating with optical core 750 are a second lens 712 that optically communicates with a fiber 710 associated with the network node of circulator 700. Similarly, core 750 also optically communicates with a lens 523 that directs electromagnetic radiation received from the network node to a photodetector 718 associated with the receive node of circulator 700.

In this illustrated confirmation the transmit node and the receive node are at the same end of circulator 700, while the network node is at another end of circulator 700. One skilled in the art will appreciate that the position of the network node, the receive node, and the transmit node may be varied. For instance, the network node may be disposed at the same end as the transmit node or the receive node may be disposed at the same end as the transmit node.

With reference to FIG. 7B, core 750 includes a first polarization beam splitter 706 optically coupled to the first lens 704 and, on a first side, to a wave plate 722, such as a half wave plate. First PBS 706 is optically coupled on a second side to second PBS 708, which is optically coupled to wave plate 714, such as a half wave plate. Wave plate 722 is optically coupled to a garnet 720, with the combination of wave plate 722 and garnet 720 being a polarization shifting assembly since garnet 720 and wave plate 722, individually and collectively, may shift the polarization of electromagnetic radiation propagating therethrough. Various other optical components may be used to perform this function.

Garnet 720 optically communicates with a third polarization beam splitter 726. Third polarization beam splitter 726 is coupled on a first side to lens 712 associated with the network node and on a second side to a mirror 716, the functions of which will be discussed in more detail hereinafter. The optical core 750 functions similarly to the optical cores discussed previously.

In core 750, light beam 740, depicted by dotted lines, propagates from laser diode 702 with well-defined SOP, for example horizontal, and follows an optical path into and through PBS 706 without reflection. Light beam 740 continues along the optical path by traveling through wave plate 722 and garnet 720. The garnet 720 and wave plate 722 rotate the polarization direction of light beam 740 from laser diode 702 each by 45°, but in opposite directions, so that the polarization direction remains horizontal after light beam 740 passes through garnet 720. The light beam 740 follows the optical path through PBS 726 without reflection and is focused by lens 712 to enter fiber 710. The fiber 710 optically couples to an optical network and allows light beam 730 to be transmitted onto the optical network.

In the backward optical path, a light beam 742 propagating from fiber 710 to photodiode 718 takes two different optical paths as PBS 726 splits light beam 742 into two different components, beam 742A with its associated path and beam 742B with its associated path. For the beam with a horizontal SOP, i.e., beam 742A, propagates along an optical path through PBS 726, garnet 720, and wave plate 722. Because of the propagation direction, garnet 720 and wave plate 722 will change the polarization direction each by 45° in the same direction. Therefore, the polarization direction of beam 742A will be changed from horizontal to vertical and light beam 742A will be reflected by PBS 706. The light beam 742A follows an optical path to PBS 708 where it is reflected to be incident upon photodiode 718.

In contrast, the beam with a vertical SOP, i.e., beam 742B, is reflected by PBS 726 following another optical path. This reflected beam is incident upon mirror 716 and reflected by mirror towards half wave plate 714. The polarization of beam 742B is changed by wave plate 714 so that its SOP is horizontal. This beam 742B then continues its optical path to photodiode 718 by passes through PBS 708 and lens 732.

It is understood that each port 702, 710 and 718 may include associated optical fibers and connectors between the optical fibers and circulator 700. For instance, standard form factor connectors, ferrules, and other types of optical connectors are contemplated and fall within the scope of the present invention. As with prior embodiments, it is also understood that alternate components that perform the same function may be substituted for the specific components of optical core 750. For instance, by way of example and not limitation, wave plates, garnets, and Faraday rotators may be configured and substituted for each other depending on the polarization rotation desired. Specific core assemblies of polarization beam splitters, beam displacers, wedges, Faraday rotators, garnets, half-wave plates, quarter-wave plates, and mirrors that accomplish the objectives of the present invention are all contemplated and included herein.

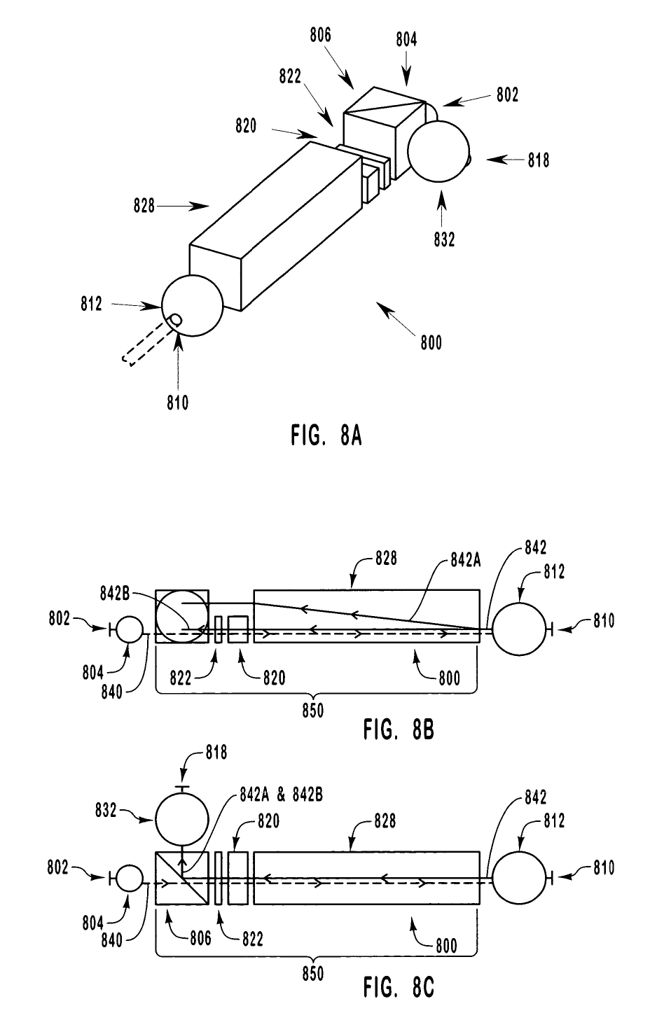

Another alternate embodiment of the optical device of the present invention is illustrated in FIGS. 8A through 8C. With reference to FIG. 8A, the circulator 800 includes a laser diode 802 optically coupled to a first lens 804. This first lens 804 is optically coupled to an optical core 850 containing various optical components that reflect, refract, and/or change the polarization state of a beam passing therethrough. Also optically communicating with optical core 850 are a second lens 812 that optically communicates with a fiber 810, illustrated in dotted lines, associated with the network node of circulator 800. Similarly, core 850 also optically communicates with a lens 823 that directs electromagnetic radiation received from the network node to a photodetector 518 associated with the receive node of circulator 800.

In this illustrated configuration the transmit node and the receive node are at the same end of circulator 800, while the network node is at another end of circulator 800. One skilled in the art will appreciate that the position of the network node, the receive node, and the transmit node may be varied. For instance, the network node may be disposed at the same end as the transmit node or the receive node may be disposed at the same end as the transmit node.

Core 850 may include a first polarization beam splitter 806 optically coupled on one end to first lens 804 and optically coupled on another side to second lens 832 which is connected to photo diode 818 in the receive port. A portion of PBS 806, such as a lower half of PBS 806 optically couples to a wave plate 822. The wave plate 822 is in turn optically coupled to a garnet 820, which optically communicates with a beam displacer 828. The combination of garnet 820 and wave plate 822 may be termed a polarization shifting assembly since garnet 820 and wave plate 822, individually and collectively, may shift the polarization of electromagnetic radiation propagating therethrough. Various other optical components may be used to perform this function.

Another portion of PBS 806, such as an upper portion thereof, optically couples to beam displacer 828 without any intermediate optical components, such as, but not limited to, lenses, garnets, wave plates, etc. Beam displacer 828 optically communicates with lens 812 and network fiber 810. The optical core 850 is defined by PBS 806, the polarization shifting assembly and beam displacer 828. It may be understood that core 850 may include various other optical components as desired by one skilled in the art in light of the teaching contained herein.

With reference to FIG. 8C, laser diode 802 creates a light beam 840, illustrated in dotted lines. This light beam 840 has a well defined, linear SOP, for example, horizontal, and follows an optical path through PBS 806 without reflection. The light beam 840 continues to follow the optical path through wave plate 822 and garnet 820. Because wave plate 822 and garnet 820 rotate the polarization direction each by 45°, but in opposite directions, light beam 840 remains with a horizontal SOP. Light beam 840 continues along the optical path through beam displacer 828 that refracts or displaces incident beams based upon their SOP. For instance, beam displacer 828 is designed such that a horizontally polarized beam performs as an o (ordinary) beam and a vertically polarized beam as an e (extraordinary) beam and is bent. Therefore, light beam 840 from laser diode 802 passes through beam displacer 828 without being displaced and propagates directly into optical fiber 810 through lens 812.

In the reverse optical direction, a light beam 842 from fiber 810 is split by beam displacer 828 into two beams with orthogonal SOPs; beam 842A and beam 842B. The beam with vertical polarization, i.e., beam 842A from beam displacer 828 is bent so that it is incident upon PBS 806 along an optical path that circumvents or does not pass through garnet 820 and wave plate 822. PBS 806 reflects beam 842A toward lens 832, which focuses beam 842A on photodiode 812.

In contrast, the beam with horizontal polarization, i.e., beam 842B, follows an optical path garnet 820 and wave plate 822. This results in the SOP of beam 842B being rotated by 90° because garnet 820 and wave plate 822 each rotate the polarization direction of the light by 45° in the same direction. Beam 842B is then reflected by PBS 806 and focused onto photodiode 812 by lens 832.

It is understood that each port 802, 812 and 832 may include associated optical fibers and connectors between the optical fibers and circulator 800. For instance, standard form factor connectors, ferrules, and other types of optical connectors are contemplated and fall within the scope of the present invention. As with prior embodiments, it is also understood that alternate components that perform the same function may be substituted for the specific components of optical core 850. For instance, by way of example and not limitation, wave plates, garnets, and Faraday rotators may be configured and substituted for each other depending on the polarization rotation desired. Specific core assemblies of polarization beam splitters, beam displacers, wedges, Faraday rotators, garnets, half-wave plates, quarter-wave plates, and mirrors that accomplish the objectives of the present invention are all contemplated and included herein.

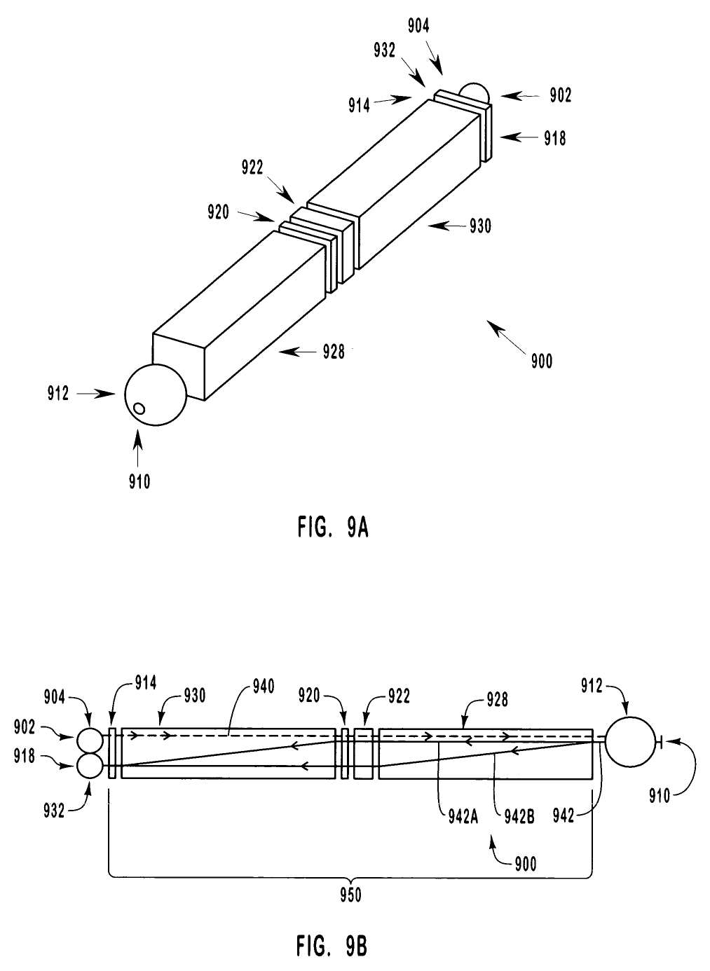

Yet another alternate embodiment of the optical device of the present invention is illustrated in FIGS. 9A and 9B. With reference to FIG. 9A, the circulator 900 includes a laser diode 802 optically coupled to a first lens 804. As with other embodiments of the present invention, this first lens 804 is optically coupled to an optical core 850 containing various optical components that reflect, refract, and/or change the polarization state of a beam passing therethrough. Also optically communicating with optical core 850 is a second lens 812 that optically communicates with a fiber 810 associated with the network node of circulator 800. Similarly, core 850 also optically communicates with a lens 823 that directs electromagnetic radiation received from the network node to a photodetector 818 associated with the receive node of circulator 800.

In this illustrated configuration the transmit node and the receive node are at the same end of circulator 800, while the network node is at another end of circulator 800. One skilled in the art will appreciate that the position of the network node, the receive node, and the transmit node may be varied. For instance, the network node may be disposed at the same end as the transmit node or the receive node may be disposed at the same end as the transmit node.

With reference to FIG. 9B, core 950 includes a first wave plate 932 that optically couples to both first lens 904, which is coupled to laser diode 902, and second lens 932 which is coupled to photo diode 918. The opposite end of wave plate 932 is optically coupled to a first beam displacer 930 which is optically coupled in series to a second wave plate 922, a garnet 920, and a second beam displacer 928, which is optically coupled to lens 912 and network fiber 910. This combination of wave plates, garnets and beam displacers is core 950. Furthermore, the combination of garnet 920 and wave plate 922 may be termed a polarization shifting assembly since garnet 920 and wave plate 922, individually and collectively, may shift the polarization of electromagnetic radiation propagating therethrough. Various other optical components may be used to perform this function.

The light beam 940, illustrated in dotted lines, from laser diode 902 with a well defined polarization direction, for example horizontal, propagates through wave plate 914, such as a half wave plate, which changes its SOP to vertical. By so doing, beam 940 follows an optical path through beam displacer 930, wave plate 922, garnet 920 and beam displacer 928. The garnet 920 and wave plate 922 each change the SOP of beam 940 by 45°, but in opposite directions such that the polarization direction remains vertical. The beam 940 then propagates along the optical path to fiber 910. If light beam 940 from laser diode 902 has a vertical SOP, wave plate 914 may be eliminated from core 950.

In the reverse optical direction, a light beam 942 from fiber 910 is split into two parallel beams after pass through beam displacer 928. This occurs because beam 942 does not have a well-defined SOP, but rather has components of various SOPs. The beams exiting from beam displacer 928, beam 942A and beam 942B, have orthogonal SOPs, i.e., vertical and horizontal polarizations. Both beams 942A and 942B propagate along optical paths into the polarization shifting assembly where wave plate 922 and garnet 920, collectively, rotate their SOPs 90°. The beams 942A and 942B follow optical paths into beam displacer 930 that combines them into a single beam with a shifted distance. The combined beam is then focused onto photodiode 918 by lens 932.

It is understood that each port 902, 912 and 918 may include associated optical fibers and connectors between the optical fibers and circulator 900. For instance, standard form factor connectors, ferrules, and other types of optical connectors are contemplated and fall within the scope of the present invention. As with prior embodiments, it is also understood that alternate components that perform the same function may be substituted for the specific components of optical core 950. For instance, by way of example and not limitation, wave plates, garnets, and Faraday rotators may be configured and substituted for each other depending on the polarization rotation desired. Specific core assemblies of polarization beam splitters, beam displacers, wedges, Faraday rotators, garnets, half-wave plates, quarter-wave plates, and mirrors that accomplish the objectives of the present invention are all contemplated and included herein.

It is also understood by those skilled in the art that the above examples are provided for illustration purposes only. While several configurations are shown where the light is input at one end of the device and output at the other end, this need not be the case. Embodiments where the light beam is input and output on the same end of the circulator also fall within the scope of the invention. Indeed, the three ports may be located in any orientation on the core, provided the individual components of the optical core are designed to function as a circulator when transmitting the light signals. The invention allows for configurations of prisms, lenses and other optical components, arranged in such a way as to allow the input and output beams to come from any direction.

In addition to the above, it may be understood that optical equivalents may be substituted for one or more of the optical components described herein. For instance, and not by way of limitation to other substitutions, a half wavelength wave plate may be substituted by two quarter wavelength wave plates or other combination of waveplates having different fraction of wavelengths.

Additionally, one skilled in the art will appreciate that one or more of the optical components described herein may include one or more coatings or films to provide the polarization shifting properties or other optical properties. For instance, one or more of the optical components may include anti-reflection coatings, filter coatings, dichroic coatings, combinations thereof, or other coatings that provide desired optical characteristics or properties.

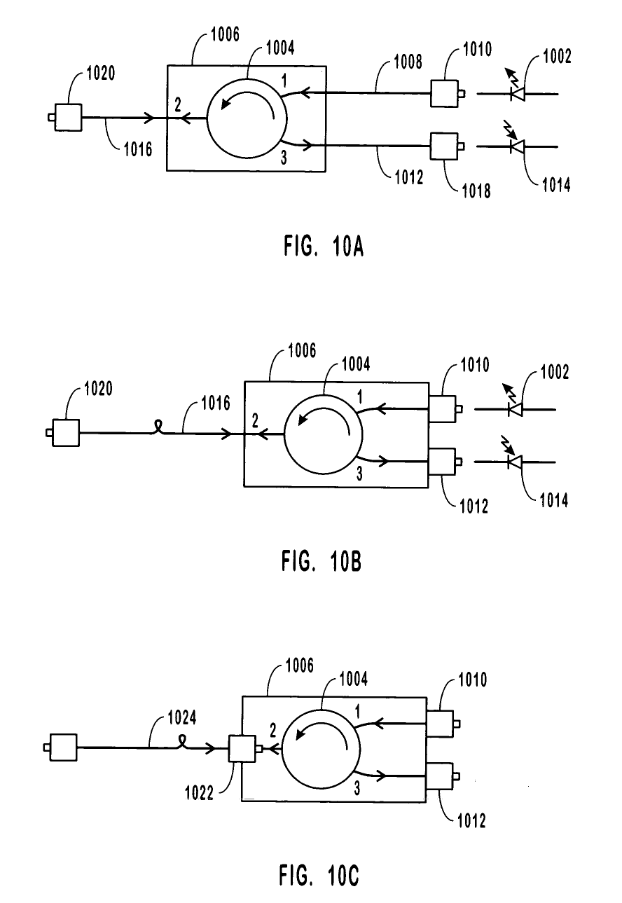

Although the above examples have been illustrated in the context where a transceiver directly inputs light into the circulator from the laser diode and directly receives light from the circulator at the photodiode, other embodiments are contemplated as well. For example, as illustrated in FIG. 10A, in another exemplary embodiment of the present invention, light from a laser diode 1002 is transmitted to port 1 of a circulator 1004 optionally disposed in a pigtail module 1006, via a polarization maintaining or single mode fiber 1008 and polarization maintaining or single mode connector 1010 to maintain the well-defined polarization. The fiber 1008 may be disposed in a dual fiber pigtail where other fiber 1012 disposed in the pigtail is adapted to propagate received data from port 3 of circulator 1004 to a photo diode 1014. A network pigtail fiber 1016 is coupled to port 2 of circulator 1004 and adapted to couple to a fiber optic network. Each of pigtail fibers 1008, 1012, and 1016 may also have a connector 1010, 1018, and 1020 respectively attached to the free end of the fiber. The connectors may be of a standard form factor such as small form factor pluggable, GPIC, or any other standard form factor connector, such that the pigtails are usable with industry standard equipment.

In another alternate embodiment of the present invention shown in FIG. 10B, which functions essentially as the device in FIG. 10A, a polarization maintaining or single mode connector 1010 is attached to the pigtail module 1006 and coupled to port 1 of the circulator 1004. Another connector 1012 is attached to the pigtail module 1006 and coupled to port 3 of the circulator 1004. The connectors 1010 and 1012 are arranged such that the pigtail module 1006 can be directly coupled into communications panels or boxes that are of standard form factors. A network pigtail fiber 1016 is coupled to port 2 of the circulator 1004. A standard form factor connector 1020 is coupled to the free end of the network pigtail fiber 1016.

In yet another embodiment shown in FIG. 10C, that is similar to the embodiment of 5B, a receptacle 1022 is coupled to port 2 of the circulator 1004 instead of the network pigtail fiber 1016. This receptacle 1022 is arranged such that a standard form factor pigtail 1024 may be coupled to the receptacle 1022 and provides an interface to an optical network. Accordingly, the functionality of an optical circulator is realized. Using this functionality, bi-directional communication along a single fiber can be accomplished.

The present invention may be embodied in other specific forms without departing from its spirit or essential characteristics. The described embodiments are to be considered in all respects only as illustrative and not restrictive.

What is claimed is:

1. An optical circulator that accomplishes bi-directional communication for use in a fiber optic communications network, the optical circulator comprising:
an optically non-reciprocal core through which passes a transmit signal in a transmit direction and a receive signal in a receive direction;
an input port optically communicating with the core and only delivering the transmit signal, with a well maintained state of polarization, to the core in the transmit direction;
an output port optically communicating with the core and only receiving the receive signal from the core in the receive direction; and
a network port optically communicating with the core and receiving the transmit signal in the transmit direction and receiving the receive signal in the receive direction;
wherein, the transmit signal input to the core at the input port is delivered to the network port, and the receive signal input to the core from the network port is output to the output port.

2. The optical circulator of claim 1, wherein an optical fiber is connected to each of the input port, the output port, and the network port.

3. The optical circulator of claim 1, wherein an optical fiber is connected to at least one of the input port, the output port, and the network port.

4. The optical circulator of claim 1, further comprising an optical fiber optically coupled to the input port, the optical fiber and the input port being polarization maintaining.

5. The optical circulator of claim 1, wherein the optically non-reciprocal core comprises:
a first optical birefringent wedge optically coupled to the input port and the receive port;
a Faraday rotator optically coupled to the first birefringent wedge, the Faraday rotator rotating the polarization of the transmit signal and the receive signal passing therethrough; and
a second optical birefringent wedge optically coupled to the Faraday rotator and to the output port;
wherein the receive signal passes, in the receive direction, through the second birefringent wedge, the Faraday rotator, and the first birefringent wedge without being refracted and the transmit signal passes, in the transmit direction, through the first birefringent wedge, the Faraday rotator, and the second birefringent wedge and is refracted into the network port.

6. The optical circulator of claim 4, wherein the Faraday rotator comprises either a non-latching magnetic material or a latching magnetic material.

7. The optical circulator of claim 4, wherein the first and second optical birefringent wedges are selected from the group consisting of a Wollaston prism, a Rochon prism, a Glan-Thomson prism, or a Glan-Taylor prism.

8. An optical circulator that accomplishes bi-directional communication for use in a fiber optic communications network, the optical circulator comprising:
an optically non-reciprocal core through which passes a transmit signal in a transmit direction and a receive signal in a receive direction, the core having a first end and a second end disposed from the first end;
an input port optically communicating with the core and only delivering the transmit signal, with a well maintained state of polarization, to the core in the transmit direction;
a first lens optically coupled to the input port and the core;
an output port optically communicating with the core and only receiving the receive signal from the core in the receive direction;
a second lens optically coupled to the output port and the core;
a network port optically communicating with the core and receiving the transmit signal in the transmit direction and receiving the receive signal in the receive direction; and
a third lens optically coupled to the network port and the core;
wherein, the transmit signal input to the core at the input port is delivered to the network port, and the receive signal input to the core from the network port is output to the output port.

9. The optical circulator of claim 8, wherein the input port and the receive port optically communicate with the core through the first end.

10. The optical circulator of claim 8, wherein the input port optically communicates with the core through the first end and the receive port communicates with the core through the second end.

11. The optical circulator of claim 8, wherein the transmit signal passes through the optically non-reciprocal core following a first optical path, the first optical path being defined by:
a first polarization beam splitter optically coupled to the first lens;
a polarization shifting assembly optically coupled to the first polarization beam splitter; and
a second polarization beam splitter optically coupled to the polarization shifting assembly.

12. The optical circulator of claim 11, wherein the polarization shifting assembly comprises a garnet and a wave plate.

13. The optical circulator of claim 11, wherein the second polarization beam splitter optically communicates with the output port.

14. The optical circulator of claim 11, wherein the second polarization beam splitter optically communicates with the network port.

15. The optical circulator of claim 11, wherein the receive signal passes through the optically non-reciprocal core following a second optical path for a first polarization state and a third optical path for a second polarization state, the second optical path being defined by the second polarization beam splitter in combination with a garnet and a mirror receiving the receiving signal having the first polarization state.

16. The optical circulator of claim 15, wherein the third optical path is defined by the receive signal having the third polarization state being at least once incident upon:
the second polarization beam splitter;
the polarization shifting assembly optically coupled to the second polarization beam splitter and the second polarization beam splitter;
the first polarization beam splitter optically coupled to the polarization shifting assembly; and
a mirror optically coupled to the first polarization beam splitter.

17. The optical circulator of claim 16, wherein the third optical path is further defined by the receive signal having the third polarization state being at least once incident upon a third polarization beam splitter optically coupled to the first polarization beam splitter and the output port.

18. The optical circulator of claim 11, wherein the receive signal passes through the optically non-reciprocal core following a second optical path for a first polarization state and a third optical path for a second polarization state, the second optical path being defined by the second polarization beam splitter in combination with a wave plate and a mirror receiving the receiving signal having the first polarization state.

19. The optical circulator of claim 8, wherein the optically non-reciprocal core comprises:
a polarization beam splitter optically coupled to the first lens;
a polarization shifting assembly optically coupled to the polarization beam splitter along a first optical path; and
a beam displacer optically coupled to the polarization shifting assembly along the first optical path and optically coupled to the polarization beam splitter along a second optical path.

20. The optical circulator of claim 19, wherein the polarization shifting assembly comprises:
a wave plate optically coupled to the polarization beam splitter along the first optical path; and
a garnet optically coupled to the wave plate along the first optical path.

21. The optical circulator of claim 19, wherein the polarization shifting assembly optically communicates with a portion of the polarization beam splitter and the beam splitter.

22. The optical circulator of claim 19, wherein the transmit signal propagates through the core along the first optical path.

23. The optical circulator of claim 19, wherein at least a portion of the receive signal propagates along the second optical path.

24. The optical circulator of claim 23, wherein at least a portion of the receive signal propagates along a third optical path defined by:
the beam displacer receiving the receive signal;
the polarization shifting assembly optically coupled to the beam displacer; and
the polarization beam splitter optically coupled to polarization shifting assembly.

25. The optical circulator of claim 8, wherein the optically non-reciprocal core comprises:
a first wave plate optically coupled to the first and second lenses;
a first beam displacer optically coupled to the half wave plate;
a polarization shifting assembly optically coupled to the first beam displacer; and
a second beam displacer optically coupled to the polarization shifting assembly and the third lens.

26. The optical circulator of claim 25, wherein the polarization shifting assembly comprises:
a wave plate optically coupled to the first beam displacer; and
a garnet optically coupled to the wave plate.

27. The optical circulator of claim 25, wherein the transmit signal propagates through the core along a first optical path.

28. The optical circulator of claim 25, wherein a first light beam transmitted from the input port travels with a well maintained state of polarization along a first optical path, passing through the first lens, the core and the third lens into the network port; and
wherein a second light beam transmitted from the network port travels along a second optical path, through the third lens and into the second beam displacer, where the second light beam is split into a first orthogonal component and a second orthogonal component, the first orthogonal component being transmitted along the second optical path through the second beam displacer without refraction, through the polarization shifting assembly and into the first beam displacer, where the first orthogonal component is refracted such that it passes through the first wave plate, through the second lens and into the output port, the second orthogonal component being refracted by the second beam displacer along a third optical path, through the polarization shifting assembly, and into the first beam displacer, where the second orthogonal component is transmitted without refraction through the first wave plate, through the second lens and into the output port.
